(19) United States
(12) Patent Application Publication
(10) Pub. No.: US 2026/0264784 A1
(43) Pub. Date: Sep. 10, 2026

(54) CONTROL SYSTEM, CONTROL METHOD, AND MANUFACTURING METHOD OF MOBILE BODY

(71) Applicant: TOYOTA JIDOSHA KABUSHIKI KAISHA, Toyota-shi (JP)

(72) Inventor: Kento IWAHORI, Nagoya-shi (JP)

(21) Appl. No.: 19/447,270

(22) Filed: Jan. 13, 2026

(30) Foreign Application Priority Data
Mar. 4, 2025 (JP) 2025-033779

(51) Int. Cl. B62D 65/18; G05D 1/65

(52) U.S. Cl. CPC B62D 65/18; G05D 1/65

(57) ABSTRACT

A control system according to the present disclosure includes a precision information acquisition unit and a vehicle controller. The precision information acquisition unit acquires precision information regarding detection precision of a sensor provided in a vehicle. The vehicle controller controls a traveling speed of the vehicle in accordance with the detection precision of the sensor. With such a configuration, the control system according to the present disclosure can improve movement efficiency of the vehicle.

### CROSS-REFERENCE TO RELATED APPLICATION

This application claims priority to Japanese Patent Application No. 2025-033779 filed on Mar. 4, 2025. The disclosure of the above-identified application, including the specification, drawings, and claims, is incorporated by reference herein in its entirety.

### BACKGROUND

### 1. Technical Field

The present disclosure relates to a control system, a control method, and a manufacturing method of a mobile body.

### 2. Description of Related Art

Japanese Unexamined Patent Application Publication No. 2024-144033 (JP 2024-144033 A) discloses a technology for performing manufacturing work on a vehicle while the vehicle is caused to move by remote control.

### SUMMARY

A speed of the vehicle that can be output during the remote control is limited in accordance with detection precision of a sensor provided in the vehicle. Therefore, when a vehicle being manufactured is caused to travel by remote control as in the technology described in JP 2024-144033 A, a traveling speed of the vehicle is lower than when a completed vehicle is caused to travel by remote control.

Meanwhile, in the vehicle being manufactured, detection precision of a sensor is improved as a manufacturing process progresses. Therefore, depending on a manufacturing stage, a sensor mounted on an incomplete vehicle may have detection precision equivalent to that of the completed vehicle. From a viewpoint of movement efficiency, such a vehicle may not be caused to travel at a low traveling speed.

That is, in the related art, there is a problem in that the movement efficiency of the vehicle cannot be sufficiently improved. JP 2024-144033 A does not disclose a technology capable of solving such a problem.

The present disclosure has been made to solve such a problem, and an object of the present disclosure is to provide a control system, a control method, and a manufacturing method of a mobile body capable of improving movement efficiency of a mobile body.

A control system according to the present disclosure includes a precision information acquisition unit and a mobile body controller. The precision information acquisition unit acquires precision information regarding detection precision of a sensor provided in a mobile body. The mobile body controller controls a movement speed of the mobile body in accordance with the detection precision of the sensor.

In the control system according to the present disclosure, the mobile body controller may control a speed of the mobile body such that the movement speed of the mobile body increases as the detection precision of the sensor improves.

In the control system according to the present disclosure, the mobile body controller may control a speed of the mobile body such that an upper limit value of a traveling speed of the mobile body increases as the detection precision of the sensor improves.

A control method according to the present disclosure acquires precision information regarding detection precision of a sensor provided in a mobile body, and controls a movement speed of the mobile body in accordance with the detection precision of the sensor.

A manufacturing method of a mobile body according to the present disclosure acquires precision information regarding detection precision of a sensor provided in a mobile body being manufactured, and controls the mobile body to move to a predetermined position where a next manufacturing process is to be performed while controlling a movement speed of the mobile body in accordance with the detection precision of the sensor.

According to the present disclosure, it is possible to provide the control system, the control method, and the manufacturing method of a mobile body capable of improving the movement efficiency of the mobile body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view showing a configuration of a control system according to a first embodiment;

FIG. 2 is a block diagram showing a configuration of a server according to the first embodiment;

FIG. 3 is a block diagram showing a configuration of the server according to the first embodiment; and

FIG. 4 is a flowchart showing an operation of the control system according to the first embodiment.

### DETAILED DESCRIPTION OF EMBODIMENTS

### First Embodiment

### Configuration of Control System

Hereinafter, a first embodiment according to the present disclosure will be described in detail with reference to the drawings. First, a configuration of the control system according to the present embodiment will be described in detail.

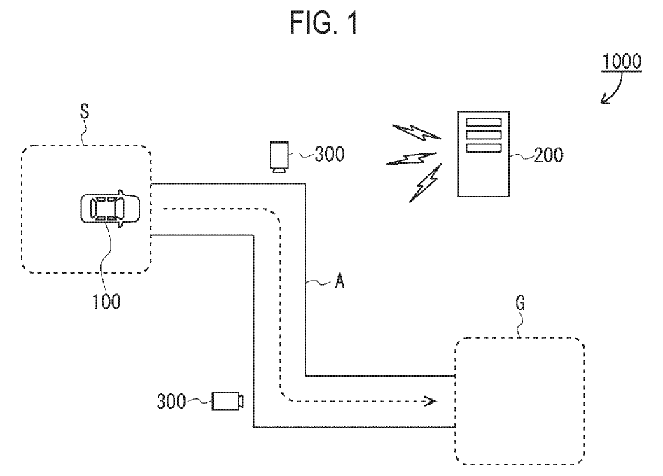

FIG. 1 is a schematic plan view showing a configuration of a control system according to the first embodiment. A control system 1000 controls movement of a mobile body. More specifically, the control system 1000 according to the present embodiment controls an operation of a vehicle 100 shown in FIG. 1.

In the present disclosure, the "mobile body" means a movable body, for example, a vehicle or an electric vertical take-off and landing aircraft (so-called flying car). The vehicle may be a vehicle that travels using wheels or a vehicle that travels using a caterpillar, and is, for example, a passenger car, a truck, a bus, a two-wheeled vehicle, a four- wheeled vehicle, a tank, and a construction vehicle. The vehicle includes a battery electric vehicle (BEV), a gasoline vehicle, a hybrid electric vehicle, and a fuel cell electric vehicle. In a case where the mobile body is other than the vehicle, the expression of "vehicle" and "car" according to the present disclosure can be replaced with "mobile body" as appropriate, and the expression of "travel" can be replaced with "move" as appropriate. Therefore, for example, a vehicle controller described later can be rephrased as the mobile body controller.

The control system 1000 according to the present embodiment controls the operation of the vehicle 100 shown in FIG. 1 to move the vehicle 100 from a departure point S to a destination point G. Further, specifically, the control system 1000 according to the present embodiment moves the vehicle 100 from the departure point S to the destination point G by causing the vehicle 100 to travel in an area A.

The control system 1000 according to the present embodiment may be introduced into a manufacturing factory of the vehicle, and may be used to control movement of the vehicle 100 being manufactured. In this case, the departure point S and the destination point G according to the present embodiment are work locations for performing various manufacturing processes on the vehicle 100. The destination point G may be referred to as a "predetermined position where a next manufacturing process is performed" with respect to the departure point S.

The term "vehicle being manufactured" used here may refer to a vehicle in a state where all the assembly is not completed as a product. The term may also refer to a vehicle in a state where all the assembly is completed as a product but an inspection needed for shipment is not completed. In addition, the term "manufacturing process" used here may include an assembly process or a processing process of the vehicle as well as an inspection process after the assembly is completed.

However, the application example of the control system 1000 according to the present disclosure is not limited to the above. For example, the control system according to the present disclosure may be used to transport a plurality of vehicles manufactured in a manufacturing factory of a vehicle to a yard. In addition, the control system according to the present disclosure may be used to load a plurality of vehicles onto a ship or a freight train.

The control system 1000 according to the present embodiment includes a server 200 and an external sensor 300. In the control system 1000, the server 200 acquires observation information of the area A from the external sensor 300 and detects position information of the vehicle 100 based on the observation information. The server 200 controls the operation of the vehicle 100 based on the position information.

The vehicle 100 is configured to travel via unmanned driving. The "unmanned driving" means driving that does not depend on a traveling operation of an occupant. Here, the traveling operation means an operation related to at least any one of "traveling", "turning", and "stopping" of the vehicle 100. The unmanned driving is implemented by automatic or manual remote control using a device located outside the vehicle 100 or by autonomous control of the vehicle 100.

Specifically, the vehicle 100 according to the present embodiment receives a traveling control signal transmitted from the server 200. The vehicle 100 controls an actuator group using the received traveling control signal to cause the vehicle 100 to travel at an acceleration and a steering angle represented by the traveling control signal. The vehicle 100 implements the unmanned driving by repeating the reception of the traveling control signal and the control of the actuator group at a predetermined cycle. The actuator group provided in the vehicle 100 includes an actuator of a drive device for accelerating the vehicle 100, an actuator of a steering device for changing a traveling direction of the vehicle 100, and an actuator of a braking device for decelerating the vehicle 100.

The occupant who does not perform the traveling operation may get on the vehicle 100 that travels via the unmanned driving. Examples of the occupant who does not perform the traveling operation include a person who simply sits on a seat of the vehicle 100 and a worker who performs work different from the traveling operation, such as assembly, inspection, or operation of switches, in a state of getting on the vehicle 100. The driving via the traveling operation performed by the occupant may be referred to as "manned driving". In addition, in the present specification, the "remote control" includes "complete remote control" in which all the operations of the vehicle 100 are completely determined from the outside of the vehicle 100, and "partial remote control" in which a part of the operations of the vehicle 100 is determined from the outside of the vehicle 100.

As described above, the vehicle 100 according to the present embodiment may be a vehicle being manufactured. That is, the vehicle 100 according to the present embodiment may have a minimum configuration capable of executing the unmanned driving, and specifically, may include a vehicle control device, an actuator group, a control device for executing communication with the server 200, and a sensor described later. That is, the vehicle 100 according to the present embodiment may not have at least a part of interior components such as a driver's seat and a dashboard mounted, and may not have at least a part of exterior components such as a bumper and a fender mounted.

As described above, the vehicle 100 according to the present embodiment includes a sensor. The sensor provided in the vehicle 100 is, for example, a sensor that detects a motion state of the vehicle 100, a sensor that detects an operation state of each part of the vehicle 100, or a sensor that detects an environment around the vehicle 100. Specifically, the sensor provided in the vehicle 100 includes, for example, a camera, a LiDAR, a millimeter wave radar, an ultrasonic sensor, a GPS sensor, an acceleration sensor, and a gyro sensor. In the following description, the sensor provided in the vehicle is referred to as an internal sensor.

The detection result of the internal sensor is transmitted to the server 200 described later and is used in generating the traveling control signal. That is, the detection result of the internal sensor is used to control the unmanned driving of the vehicle 100.

Here, the detection precision of the internal sensor is improved as the manufacturing process progresses. For example, the detection precision of the internal sensor may be improved by being tuned as the manufacturing process progresses. In addition, the detection precision of the internal sensor may be improved by the number of the internal sensors attached being increased as the manufacturing process progresses.

In a case where the detection precision of the internal sensor is improved, the server 200 can control the operation of the vehicle 100 with higher precision. Therefore, in a case where the detection precision of the internal sensor is improved, the server 200 can cause the vehicle 100 to travel at a higher speed.

Details will be described later, but the server 200 according to the present embodiment is configured to acquire precision information regarding the detection precision of the sensor provided in the vehicle 100, and control the speed of the vehicle 100 based on the acquired precision information. As a result, the control system 1000 according to the present embodiment can improve the movement efficiency of the vehicle 100.

The external sensor 300 is a sensor located outside the vehicle 100. The external sensor 300 includes a communication device and can communicate with another device such as the server 200 by wired communication or wireless communication. More specifically, the external sensor 300 according to the present embodiment is a sensor that observes a movement area A in which the mobile body moves. The external sensor 300 transmits the observation information that is an observation result of the movement area A to the server 200.

Specifically, the external sensor 300 is configured by a camera. The camera as the external sensor 300 captures an image of the movement area A and outputs a captured image as the observation information. However, the external sensor 300 according to the present embodiment is not limited to the camera, and may be, for example, light detection and ranging (LiDAR). In this case, the detection result output by the external sensor 300 may be three-dimensional point cloud data of the movement area A. That is, the external sensor 300 according to the present embodiment may be any sensor as long as the sensor can output information that can be used to detect the position information of the vehicle by observing the movement area A.

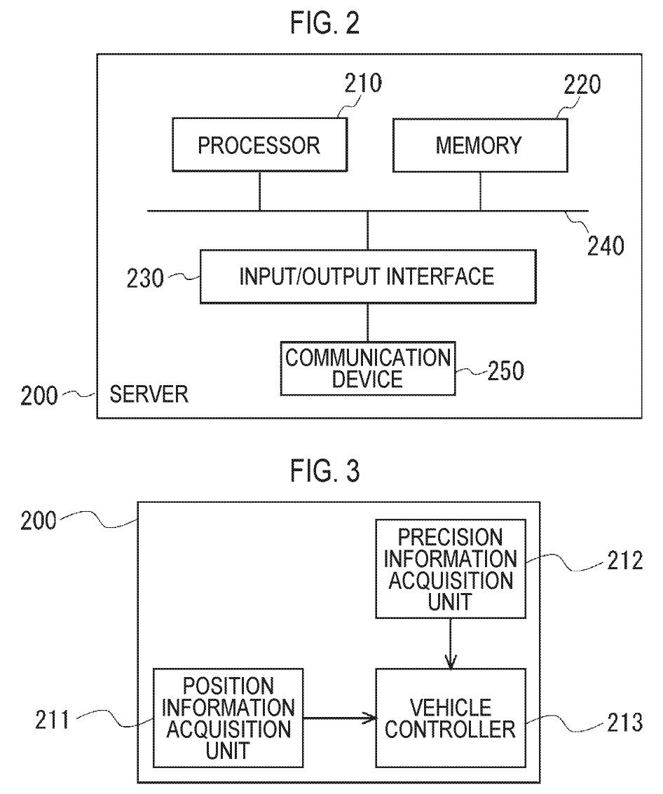

FIG. 2 is a block diagram showing a configuration of a server according to the first embodiment. The server 200 is configured by a computer including a processor 210, a memory 220, an input/output interface 230, and an internal bus 240.

The processor 210, the memory 220, and the input/output interface 230 are connected to be bidirectionally communicable with each other via the internal bus 240. A communication device 250 for communicating with various devices outside the server 200 is connected to the input/output interface 230. The communication device 250 can communicate with the vehicle 100 via wireless communication, and can communicate with the external sensor 300 via wired communication or wireless communication. The processor 210 executes a program stored in the memory 220 to realize various functions including functions as a position information acquisition unit 211, a precision information acquisition unit 212, and a vehicle controller 213.

The position information acquisition unit 211 acquires the observation information from the external sensor 300. The position information acquisition unit 211 detects the position information of the vehicle 100 based on the observation information. The position information acquisition unit 211 outputs the detected position information of the vehicle 100 to the vehicle controller 213. More specifically, the position information acquisition unit 211 detects an external shape of the vehicle 100 from the captured image acquired as the observation information, and calculates coordinates of a positioning point of the vehicle 100 in a coordinate system in the captured image, that is, a local coordinate system. The position information acquisition unit 211 detects the position information of the vehicle 100 by converting the calculated local coordinates into coordinates in a global coordinate system.

For example, the external shape of the vehicle 100 included in the captured image may be detected by inputting the captured image to a detection model using artificial intelligence. That is, the position information acquisition unit 211 according to the present embodiment may detect the position information of the vehicle 100 by inputting the acquired observation information to an artificial intelligence model that uses the observation information as input information and outputs the position information of the mobile body.

Examples of the detection model include a trained machine learning model that has been trained to implement any of semantic segmentation and instance segmentation. As the machine learning model, for example, a convolutional neural network (CNN) that has been trained by supervised learning using a training data set can be used. The training data set has, for example, a plurality of training images including the vehicle 100 and a label indicating whether each area in the training image is an area indicating the vehicle 100 or an area indicating an area other than the vehicle 100. When the CNN is trained, parameters of the CNN are preferably updated by backpropagation (error backpropagation method) to reduce an error between the output result of the detection model and the label. In addition, the position information acquisition unit 211 estimates, for example, the position of the vehicle 100 based on a direction of a movement vector of the vehicle 100 calculated from a position change of a feature point of the vehicle 100 between frames of the captured image by using an optical flow method. As a result, the orientation of the vehicle 100 can be acquired.

The position information acquisition unit 211 may acquire the position information of the vehicle 100 with reference to the detection result of the internal sensor. That is, the position information acquisition unit 211 may acquire the position information of the vehicle 100 by using the detection results of both the external sensor 300 and the internal sensor. In addition, the position information acquisition unit 211 may acquire the position information by using solely the detection result of the internal sensor. In this case, the external sensor 300 is not a needed configuration.

The precision information acquisition unit 212 acquires precision information regarding the detection precision of the internal sensor. The precision information acquisition unit 212 outputs the acquired precision information to the vehicle controller 213. The detection precision of the sensor used here refers to the detection precision of the internal sensor. As described above, the detection precision of the internal sensor is improved as the manufacturing process progresses.

The precision information acquisition unit 212 may acquire any information as the precision information as long as the information that can be used to evaluate or estimate the detection precision of the internal sensor. For example, the precision information acquisition unit 212 may acquire information regarding a progress status of the manufacturing process as the information regarding the detection precision of the internal sensor. In addition, for example, the precision information acquisition unit 212 may acquire the detection result of the internal sensor. The quality of the detection result may be evaluated, and the evaluation result may be output as the precision information.

In addition, the precision information acquisition unit 212 may acquire information regarding the detection precision of the internal sensor from a control device of the vehicle 100. In this case, the control device of the vehicle 100 may be configured to evaluate the precision of the internal sensor. The precision information acquisition unit 212 may acquire the result of the evaluation as the precision information. In addition, in this case, the control device of the vehicle 100 may acquire an operation parameter of the internal sensor. The precision information acquisition unit 212 may acquire the operation parameter as the precision information. Specific examples of the operation parameter include a frequency band of the millimeter wave radar and a detection interval.

The vehicle controller 213 acquires the position information from the position information acquisition unit 211 and acquires the precision information from the precision information acquisition unit 212. The vehicle controller 213 controls the operation of the vehicle 100 based on the position information and the precision information. Hereinafter, an aspect of the vehicle controller 213 controlling the vehicle 100 will be described in further detail.

The vehicle controller 213 determines a target position to which the vehicle 100 is to head next. The target position is represented by, for example, coordinates of X, Y, and Z in the global coordinate system. The vehicle controller 213 stores a reference route that is a route on which the vehicle 100 is to travel, in advance. The route is represented by a node indicating a departure point, a node indicating a passing point, a node indicating a destination, and a link connecting the respective nodes. The vehicle controller 213 determines the target position to which the vehicle 100 is to head next by using the position information and the reference route. The vehicle controller 213 determines the target position on the reference route ahead of the current position of the vehicle 100.

The vehicle controller 213 calculates a traveling speed of the vehicle 100 from the transition of the position of the vehicle 100, and compares the calculated traveling speed with a target speed. As a whole, the vehicle controller 213 determines the acceleration such that the vehicle 100 is accelerated when the traveling speed is lower than the target speed, and determines the acceleration such that the vehicle 100 is decelerated when the traveling speed is higher than the target speed. The vehicle controller 213 may be configured to acquire the traveling speed of the vehicle 100 based on the detection result of the internal sensor.

Here, the vehicle controller 213 controls the movement speed of the vehicle 100 in accordance with the detection precision of the sensor. That is, in the present embodiment, the vehicle controller 213 determines the target speed in accordance with the detection precision of the internal sensor.

More specifically, the vehicle controller 213 controls the speed of the vehicle 100 such that the traveling speed of the vehicle 100 increases as the detection precision of the sensor is improved. That is, in the present embodiment, the target speed determined by the vehicle controller 213 increases as the detection precision of the internal sensor is improved.

In addition, the vehicle controller 213 may control the speed of the vehicle 100 such that an upper limit value of the traveling speed of the vehicle 100 increases as the detection precision of the sensor is improved. That is, the vehicle controller 213 may be configured to increase an upper limit value of the target speed that can be determined as the detection precision of the internal sensor is improved.

With such a configuration, the control system 1000 according to the present embodiment can improve the traveling speed of the vehicle 100. As a result, the control system 1000 according to the present embodiment can improve the movement efficiency of the vehicle 100.

In addition, the vehicle controller 213 determines the steering angle and the acceleration such that the vehicle 100 does not deviate from the reference route in a case where the vehicle 100 is located on the reference route, and in a case where the vehicle 100 is not located on the reference route, the vehicle controller 213 determines the steering angle and the acceleration such that the vehicle 100 returns to the reference route. In this case, in other words, the steering angle and the acceleration are determined such that the vehicle 100 returns to the reference route in a case where the vehicle 100 deviates from the reference route.

The vehicle controller 213 transmits the generated traveling control signal to the vehicle 100. The vehicle controller 213 repeats the acquisition of the position of the vehicle 100, the determination of the target position, the generation of the traveling control signal, the transmission of the traveling control signal, and the like at a predetermined cycle. With such a configuration, the vehicle controller 213 according to the present embodiment can control the unmanned driving of the vehicle 100.

As described above, the control system according to the present embodiment is configured to acquire the precision information regarding the detection precision of the sensor provided in the vehicle 100, and control the movement speed of the vehicle 100 in accordance with the acquired detection precision. With such a configuration, the control system 1000 according to the present embodiment can improve the traveling speed of the vehicle 100. As a result, the control system 1000 according to the present embodiment can improve the movement efficiency of the vehicle 100.

### Operation of Vehicle and Control System

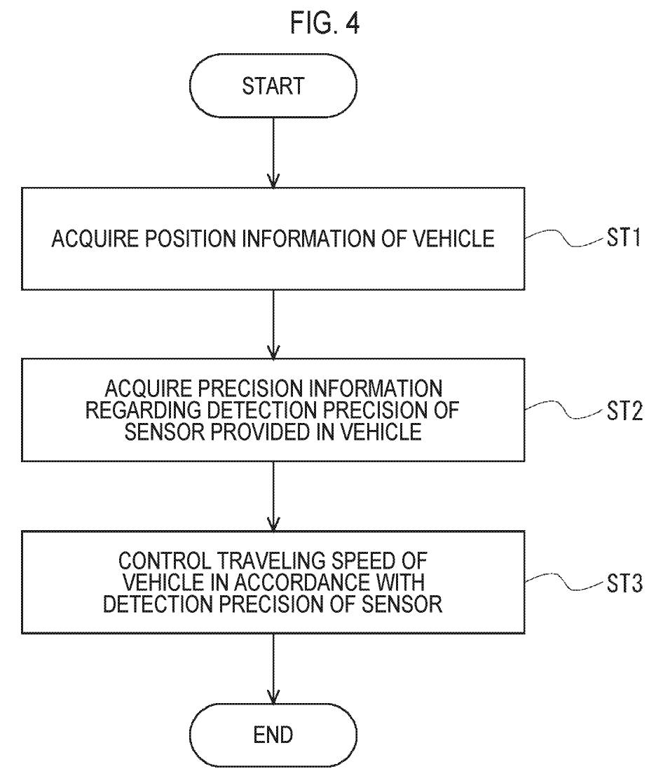

Subsequently, the operation of the control system according to the present embodiment, that is, the control method according to the present embodiment, will be described in more detail. FIG. 4 is a flowchart for describing the control method according to the first embodiment. In the following description, FIGS. 1, 2, and 3 will be appropriately referred to.

In the processing procedure of FIG. 4, the processor 210 of the server 200 executes the program stored in the memory 220 to function as the position information acquisition unit 211, the precision information acquisition unit 212, and the vehicle controller 213.

In the control method according to the present embodiment, first, the processor 210 acquires the position information of the vehicle 100 (ST1). That is, in ST1, the processor 210 functions as the position information acquisition unit 211. More specifically, in ST1, the processor 210 acquires the observation information from the external sensor 300 and acquires the detection result from the internal sensor. The position of the vehicle 100 is specified based on at least one of the observation information of the external sensor 300 and the detection result of the internal sensor, and thus the position information of the vehicle 100 is acquired.

Next, the processor 210 acquires the information regarding the detection precision of the sensor provided in the vehicle (ST2). That is, in ST2, the processor 210 functions as the precision information acquisition unit 212.

More specifically, in ST2, the processor 210 acquires the information regarding the detection precision of the internal sensor. Specifically, in ST2, the processor 210 acquires the information on the progress status of the manufacturing process, the quality evaluation of the detection result of the internal sensor by the vehicle control device, the operation parameter of the internal sensor, and the like to acquire the detection precision information of the internal sensor. In addition, in ST2, the processor 210 may be configured to acquire the detection result of the internal sensor and evaluate the quality of the acquired detection result to acquire the detection precision information of the internal sensor.

The execution order of ST1 and ST2 may be reversed. That is, the control system according to the present disclosure may execute ST1 after executing ST2. In addition, ST1 and ST2 may be executed in parallel.

Finally, the processor 210 controls the traveling speed of the vehicle 100 in accordance with the detection precision of the sensor (ST3), and the control system 1000 according to the present embodiment ends the series of operations. That is, in ST3, the processor 210 functions as the vehicle controller 213. The processor 210 repeats the operations of ST1, ST2, and ST3 at a predetermined cycle.

More specifically, in ST3, the processor 210 outputs the traveling control signal of the vehicle 100 and transmits the traveling control signal to the vehicle 100. Here, the generated traveling control signal includes a control instruction value related to at least one of the traveling speed and the acceleration of the vehicle 100.

In ST3, the processor 210 according to the present embodiment refers to the acquired detection precision of the internal sensor in a case of determining the control instruction value. Specifically, in ST3, the processor 210 according to the present embodiment refers to the acquired detection precision of the internal sensor to determine the control instruction value such that the vehicle 100 travels at a high speed as the detection precision of the internal sensor is improved. With the above-described configuration, in ST3, the processor 210 can reflect the detection precision of the internal sensor in the traveling speed of the vehicle 100.

As described above, in the control method according to the present embodiment, the precision information regarding the detection precision of the sensor provided in the vehicle 100 is acquired, and the movement speed of the vehicle 100 is controlled in accordance with the acquired detection precision. With such a configuration, the control method according to the present embodiment can improve the traveling speed of the vehicle 100. As a result, the control system 1000 according to the present embodiment can improve the movement efficiency of the vehicle 100.

As described above, the control method according to the present embodiment can improve the movement efficiency of the vehicle. Therefore, the control method according to the present embodiment achieves a special effect that the manufacturing efficiency of the vehicle can be improved by being applied to the movement control of the vehicle being manufactured. That is, the control method according to the present embodiment achieves a special effect by being used as a control method for the vehicle 100 to execute the unmanned driving from a predetermined position where the manufacturing process is performed to a predetermined position where the next manufacturing process is performed. That is, the control method according to the present embodiment achieves a special effect by being used as a manufacturing method of the vehicle 100.

### Other Embodiments

### Other Embodiment 1

In the first embodiment, the processing from the acquisition of the vehicle position information to the generation of the traveling control signal is executed by the server 200. On the other hand, the vehicle 100 may execute at least a part of the processing from the acquisition of the vehicle position information to the generation of the traveling control signal. For example, the following forms (1) and (2) may be adopted.
(1) The server 200 may acquire the vehicle position information of the vehicle 100, determine the target position to which the vehicle 100 should head next, and generate the route from the current position of the vehicle 100 represented by the acquired vehicle position information to the target position. The server 200 may generate a route to the target position between the current position and the destination or may generate a route to the destination. The server 200 may transmit the generated route to the vehicle 100. The vehicle 100 may generate the traveling control signal for causing the vehicle 100 to travel on the route received from the server 200, and control the actuator group by using the generated traveling control signal.
(2) The server 200 may acquire the position information of the vehicle 100 and transmit the acquired vehicle position information to the vehicle 100. The vehicle 100 may determine the target position to which the vehicle 100 should head next, generate the route from the current position of the vehicle 100 represented by the received vehicle position information to the target position, generate the traveling control signal such that the vehicle 100 travels on the generated route, and control the actuator group by using the generated traveling control signal.

### Other Embodiment 2

In the first embodiment, the vehicle control device may acquire the detection result of the internal sensor, detect the current position information of the vehicle 100 based on the acquired detection result, and output the control parameter based on the detected current position information. That is, the control system according to the present disclosure may be a system mounted on the vehicle 100.

### Supplement

The transport of the vehicle 100 using the traveling of the vehicle 100 via the unmanned driving will also be referred to as "autonomous transport". In addition, a configuration for implementing the autonomous transport is also referred to as "vehicle remote control autonomous driving transport system". In addition, a production method of producing the vehicle 100 by using the autonomous transport is also referred to as "autonomous production". In the autonomous production, for example, at the factory FC that manufactures the vehicle 100, at least a part of the transport of the vehicle 100 is implemented by the autonomous transport.

Although the present disclosure has been described in detail with reference to the above-described embodiments, the present disclosure is not limited to the configuration of the above-described embodiments. It is needless to say that various modifications, corrections, and combinations that can be made by those skilled in the art within the scope of the disclosure as defined by the appended claims are included.

What is claimed is:

1. A control system comprising:
a precision information acquisition unit configured to acquire precision information regarding detection precision of a sensor provided in a mobile body; and
a mobile body controller configured to control a movement speed of the mobile body in accordance with the detection precision of the sensor.

2. The control system according to claim 1, wherein the mobile body controller is configured to control a speed of the mobile body such that the movement speed of the mobile body increases as the detection precision of the sensor improves.

3. The control system according to claim 1, wherein the mobile body controller is configured to control a speed of the mobile body such that an upper limit value of a traveling speed of the mobile body increases as the detection precision of the sensor improves.

4. A control method comprising:
acquiring precision information regarding detection precision of a sensor provided in a mobile body; and
controlling a movement speed of the mobile body in accordance with the detection precision of the sensor.

5. A manufacturing method of a mobile body, the manufacturing method comprising:
acquiring precision information regarding detection precision of a sensor provided in a mobile body being manufactured; and
controlling the mobile body to move to a predetermined position where a next manufacturing process is to be performed while controlling a movement speed of the mobile body in accordance with the detection precision of the sensor.
